(19) United States
(12) Patent Application Publication
(10) Pub. No.: US 2008/0128341 A1
(43) Pub. Date: Jun. 5, 2008

(54) MICRO FILTRATION DEVICE FOR SEPARATING BLOOD PLASMA AND FABRICATION METHOD THEREFOR

(75) Inventors: Won-Ick JANG, Daejon (KR); Kwang-Hyo Chung, Daejon (KR); Hyeon-Bong Pyo, Daejon (KR); Seon-Hee Park, Daejon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejon (KR)

(21) Appl. No.: 11/933,081

(22) Filed: Oct. 31, 2007

(30) Foreign Application Priority Data
Dec. 4, 2006 (KR) 10-2006-0121250
Jul. 18, 2007 (KR) 10-2007-0071671

(51) Int. Cl. B01D 21/34; B29C 65/00

(52) U.S. Cl. 210/137; 156/182

(57) ABSTRACT

Provided is a micro filtration device for separating blood plasma from whole blood without external actuation, and a method for fabricating the micro filtration device. The micro filtration device for separating blood plasma from whole blood includes: a whole blood inlet through which whole blood is introduced; a blood plasma outlet through which blood plasma separated from whole blood is discharged; a micro channel for connecting the whole blood inlet and the blood plasma outlet; a micro pump formed under the whole blood inlet to generate an air pressure without external actuation for moving whole blood from the whole blood inlet toward the blood plasma outlet through the micro channel; and a microstructure formed in the micro channel for separating blood plasma from the whole blood.

### CROSS-REFERENCE(S) TO RELATED APPLICATIONS

The present invention claims priority of Korean Patent Application Nos. 10-2006-0121250 and 10-2007-0071671, filed on Dec. 4, 2006, and Jul. 18, 2007, respectively, which are incorporated herein by reference.

### BACKGROUND OF THE INVENTION

1. Field of the Invention

The present invention relates to a micro filtration device and a method for fabricating the micro filtration device; and, more particularly, to a micro filtration device for separating blood plasma from whole blood without external actuation, and a method for fabricating the micro filtration device.

This work was partly supported by the Information Technology (IT) research and development program of the Korean Ministry of Information and Communication (MIC) and/or the Korean Institute for Information Technology Advancement (IITA) [2006-S-007-01, “Ubiquitous Health Monitoring Module and System Development”].

2. Description of Related Art

Whole blood ceaselessly circulates throughout a body and collects various informations from the body. Thus, the whole blood is used as a useful indicator in medical examinations.

Particularly, protein chips (a kind of biochip) are used for separating a specific protein from blood plasma separated from a whole blood sample and concentrating the separated protein so as to detect a disease such as a cancer. Human whole blood includes blood cells such as red blood cells, white blood cells, and blood platelets, and blood plasma including water, protein, fat, sugariness, and inorganic ions. Therefore, there is a need for a highly sensitive biochip capable of separating blood cells and other unnecessary components from whole blood to collect and concentrate a specific protein.

Various methods have been proposed for separating blood plasma from whole blood. For example, microstructures smaller than blood cells are disposed in a blood flow channel, and whole blood is forced to pass through the blood flow channel using an external syringe pump so as to separate blood cells from the whole blood using the microstructures and collect the remaining blood plasma. According to another method, blood plasma is separated from whole blood using a low barrier wall, which blood cells cannot pass through but blood plasma can pass through by capillary action. According to yet another method, blood cells are separated from whole blood using a porous medium or a membrane disposed at a side of a blood flow channel or in the middle of the blood flow channel. According to still another method, whole blood is divided into a blood plasma layer and a blood cell layer by allowing heavier blood cells to move down, and then blood plasma is separated from the layered whole blood. According to further another method, an electric signal is applied to whole blood to deflect a stream of blood cells.

Examples of conventional apparatuses and methods for separating blood plasma from whole blood will now be described.

According to a related art, blood plasma is separated from whole blood without consuming any power by using capillary action. In detail, whole blood is forced by capillary action to pass through a blood extractor, which blood cells cannot pass through but blood plasma can pass through.

According to another related art, a blood collector, a blood plasma separator, and an analyzer are sequentially disposed, and blood plasma is automatically separated from a blood stream using a centrifugal force. The related art is characterized in that some of channels are adjusted in size to collect blood cells while allowing blood plasma to flow smoothly.

According to yet another related art, a pressure pulse having a high magnitude and short width is periodically applied to an inlet of a micro channel formed in a biochip to change a stream of whole blood so as to separate bio-particles from the whole blood. That is, it is unnecessary to dispose a filter in the micro channel to separate bio-particles.

According to still another related art, a blood processing filter layer and a sheet-form spacer layer allowing a smoother blood flow than the blood processing filter layer are stacked and rolled, and an end of the sheet-form spacer layer is exposed to the outer or inner peripheral surface of a filter material. The disclosed filter device is characterized in that the stack structure of the blood processing filter layer and the sheet-form spacer layer is spiral, and a material such as non-woven fabric, woven fabric, a porous sheet is used as the filter material.

However, in the conventional apparatuses and methods, blood cells can be accumulated on a structure such as microstructures, a barrier wall, a membrane, or a porous medium formed for separating blood plasma from whole blood. In this case, a blood channel can be narrowed or closed, thereby decreasing blood plasma separating efficiency or increasing blood plasma separating time. Moreover, when an external device such as a syringe pump is used to move a blood sample, a blood driving mechanism becomes complicated, and thus it is difficult to continuously and efficiently separate and concentrate blood plasma.

### SUMMARY OF THE INVENTION

An embodiment of the present invention is directed to providing a micro filtration device for separating blood plasma from whole blood without using an external device such as a syringe pump, and a method for fabricating the micro filtration device.

Another embodiment of the present invention is directed to providing a micro filtration device for separating blood plasma from whole blood using a microstructure without a decrease in blood plasma separating efficiency caused by blood cells accumulated on the microstructure, and a method for fabricating the micro filtration device.

Another embodiment of the present invention is directed to providing a micro filtration device for separating a specific bio-substance from separated blood plasma and concentrating the separated bio-substance, and a method for fabricating the micro filtration device.

Another embodiment of the present invention is directed to providing a micro filtration device that can be fabricated with lower costs for being used as a disposable biochip, and a method for fabricating the micro filtration device.

In accordance with an aspect of the present invention, there is provided a micro filtration device for separating blood plasma from whole blood, which includes: a whole blood inlet through which whole blood is introduced; a blood plasma outlet through which blood plasma separated from whole blood is discharged; a micro channel for connecting the whole blood inlet and the blood plasma outlet; a micro pump formed under the whole blood inlet to generate an air pressure without external actuation for moving whole blood from the whole blood inlet toward the blood plasma outlet through the micro channel; and a microstructure formed in the micro channel for separating blood plasma from the whole blood.

The micro pump may include: a closed cavity; a micro heater generating heat for expanding air filled in the cavity; and a membrane formed in the cavity and deforming according to pressure variations of the air filled in the cavity.

The microstructure may include: a first microstructure configured to separate blood plasma from whole blood; and a second microstructure to which a complementary capture probe ligand is coupled for separating and concentrating a desired bio-substance.

The whole blood inlet and the blood plasma outlet may be formed at an upper substrate, and the micro channel and the micro pump may be formed at a lower substrate. Herein, the upper and lower substrates are aligned with each other and sealed, and each of the upper and lower substrates is formed of a plastic polymer.

The micro filtration device may further include a whole blood bath formed between the whole blood inlet and the micro pump for storing whole blood introduced through the whole blood inlet, and a blood plasma bath formed under the blood plasma outlet for storing blood plasma separated from whole blood.

In accordance with another aspect of the present invention, there is provided a method for fabricating a micro filtration device includes the steps of: a) forming a whole blood inlet at one side of an upper substrate for introducing whole blood; b) forming a blood plasma outlet at the other side of the upper substrate for discharging blood plasma separated from whole blood; c) forming a micro pump at a portion of a lower substrate corresponding to the whole blood inlet for generating an air pressure without external actuation to move whole blood; d) forming a micro channel at the lower substrate to connect the whole blood inlet and the blood plasma outlet, and forming a microstructure in the micro channel so as to separate blood plasma from whole blood; and e) bonding the upper substrate and the lower substrates for hermetical sealing.

The step c) may include the steps of: c1) forming a micro heater at the lower substrate; c2) forming a support layer around the micro heater to form a cavity; and c3) forming a membrane on the support layer to close the cavity.

The step d) includes the steps of: d1) bonding a dry film resist (DFR) layer to the lower substrate; and d2) exposing and developing the dry film resist layer using a mask having a pattern corresponding to the micro channel and the microstructure.

The upper and lower substrates may be sealed by laminating, and each of the upper and lower substrates is formed of a plastic polymer.

The method further includes the step of: f) forming a complementary capture probe ligand on the microstructure for separating a desired bio-substance.

The method further includes the steps of: f) forming a whole blood bath at the lower substrate for storing whole blood; and g) forming a blood plasma bath at the lower substrate for storing blood plasma separated from whole blood.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1A is a view illustrating a micro filtration device in accordance with an embodiment of the present invention.

FIG. 1B is a sectional view taken along line Y-Y′ of FIG. 1A.

FIGS. 2A to 2H illustrate sectional views corresponding to a section taken along line X-X′ of FIG. 1A for explaining a method for fabricating a micro filtration device in accordance with an embodiment of the present invention.

FIG. 3 is a view illustrating experiment procedures for separating blood plasma using a micro filtration device fabricated in accordance with an embodiment of the present invention.

FIG. 4 is an enlarged view illustrating a microstructure portion of FIG. 3.

### DESCRIPTION OF SPECIFIC EMBODIMENTS

The advantages, features and aspects of the invention will become apparent from the following description of the embodiments with reference to the accompanying drawings, which is set forth hereinafter. In the drawings, the thicknesses of layers and regions are exaggerated for clarity. It will also be understood that when a layer is referred to as being “on” another layer or substrate, it can be directly on the other layer or substrate, or intervening layers may also be present. Further, in the drawings, like reference numerals denote like elements.

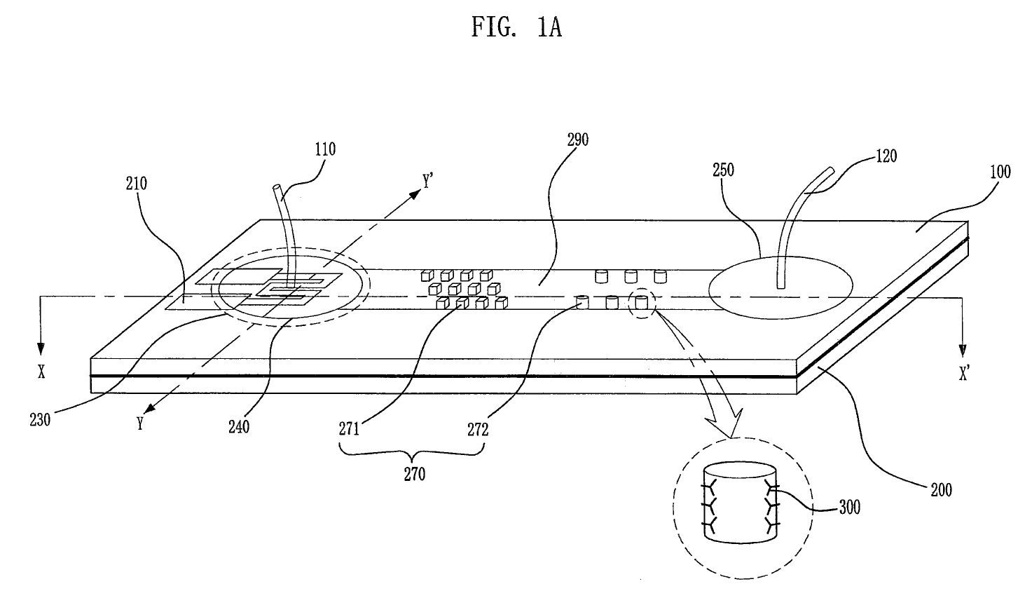

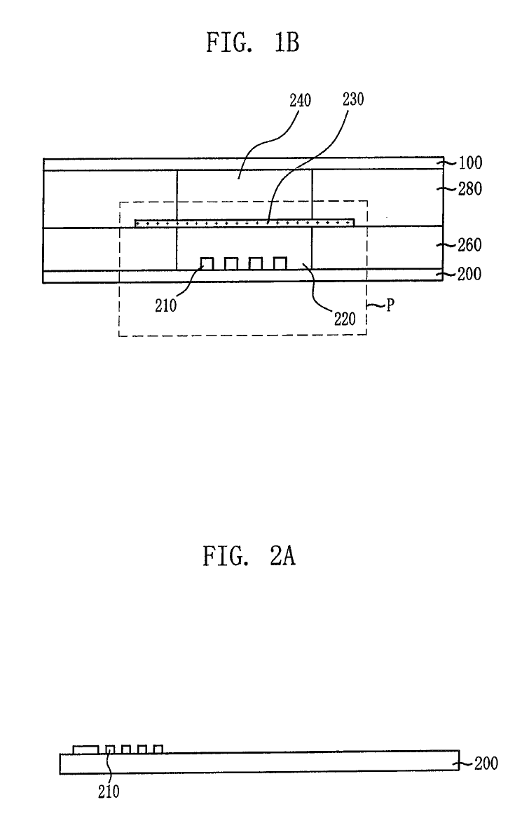

FIG. 1A is a view illustrating a micro filtration device in accordance with an embodiment of the present invention, and FIG. 1B is a sectional view taken along line Y-Y′ of FIG. 1A.

Referring to FIGS. 1A and 1B, the micro filtration device of the present invention includes a whole blood inlet 110, a blood plasma outlet 120, a micro channel 290, a micro pump (P), and microstructures 270. Whole blood is introduced into the micro filtration device through the whole blood inlet 110. Blood plasma separated from the whole blood is discharged through the blood plasma outlet 120. The micro channel 290 connects the whole blood inlet 110 and the blood plasma outlet 120.

The micro pump (P) is disposed under the whole blood inlet 110 and generates air pressure without external actuation so as to move the whole blood from the whole blood inlet 110 to the blood plasma outlet 120 through the micro channel 290. The microstructures 270 are disposed in the micro channel 290 for separating blood plasma from the whole blood introduced through the whole blood inlet 110. The whole blood inlet 110 and the blood plasma outlet 120 may be disposed at an upper substrate 100, and the micro channel 290, the microstructures 270, and the micro pump (P) may be disposed at a lower substrate 200. The upper substrate 100 and the lower substrate 200 may be aligned with each other and then may be sealed.

The micro pump (P) may include a closed cavity 220, a micro heater 210, and a membrane 230. The micro heater 210 generates heat to expand air filled in the closed cavity 220. The membrane 230 is formed in the cavity 220 and deforms according the pressure of the air filled in the cavity 220. The micro pump (P) can further include a support layer 260 for enclosing the micro heater 210 and supporting the membrane 230.

A pulse bias may be applied to the micro heater 210 from an external source. The micro heater 210 may be formed of gold (Au). The support layer 260 may be an insulation layer formed of, for example, silicon oxide (SiO₂).

The microstructures 270 may include first microstructures 271 and second microstructures 272. The first microstructures 271 may be used to separate blood plasma from whole blood, and the second microstructures 272 may include complementary capture probe ligands 300 for separating and concentrating a desired bio-substance from the separated blood plasma. The first microstructures 271 may be arranged at intervals of 5 μm since blood cells such as red blood cells, white blood cells, and blood platelets range in size from about 7 μm to about 8 μm.

The microstructures 270 may be shaped like a cylinder, a cube, a cuboid, or a polyhedron. At least one microstructure 270 may be disposed in the micro channel 290 (a plurality of microstructures 270 is shown in the embodiment of FIG. 1A). Furthermore, the microstructures 270 may be arranged in the micro channel 290 at regular or irregular intervals.

In the current embodiment of the present invention, the micro filtration device may further include a whole blood bath 240 disposed between the whole blood inlet 110 and the micro pump (P) to store whole blood received through the whole blood inlet 110. The micro filtration device of the current embodiment may further include a blood plasma bath 250 disposed under the blood plasma outlet 120 to store blood plasma separated from whole blood. The whole blood bath 240 and the blood plasma bath 250 can be connected through the micro channel 290.

The upper substrate 100 and the lower substrate 200 can be formed of one of plastic polymer, silicon, glass, and rubber. For example, the upper substrate 100 and the lower substrate 200 can be formed of inexpensive plastic polymer to allow the micro filtration device to be used for a disposable biochip. For example, the upper substrate 100 and the lower substrate 200 can be formed of a plastic polymer selected from the group consisting of cycloolefin copolymer (COC), poly-dimethyl siloxane (PDMS), polymethylmethacrylate (PMMA), polycarbonate (PC), polyamide (PA), polyethylene (PE), polypropylene (PP), polyphenylene ether (PPE), polystyrene (PS), polyoxymethylene (POM), polyetheretherketone (PEEK), polytetrafluoroethylene (PTFE), polyvinylchloride (PVC), polyvinylidene fluoride (PVDF), polybutyleneterephthalate (PBT), fluorinated ethylenepropylene (FEP), perfluoralkoxyalkane (PFA) and combinations thereof.

An operation of the micro filtration device will now be described in accordance with the present invention. First, a whole blood sample is introduced into the micro filtration device through the whole blood inlet 110 and is temporarily stored in the whole blood bath 240. After the whole blood bath 240 is filled up with the whole blood sample, the whole blood sample may be stationary.

In this state, a pulse bias can be applied to the micro heater 210 disposed under the whole blood bath 240 to move the whole blood sample. For example, a predetermined voltage can be applied to the micro heater 210 at predetermined intervals to heat and cool the micro heater 210 for expanding and contracting air filled in the closed cavity 220.

Thus, the pressure of the air filled in the cavity 220 varies, causing the membrane 230 to deform in a vertical direction. The whole blood sample may be kept in the whole blood bath 240 at a temperature below 36.5° C. to prevent bio-substances contained in the whole blood sample from being damaged by heat transferred from the micro heater 210.

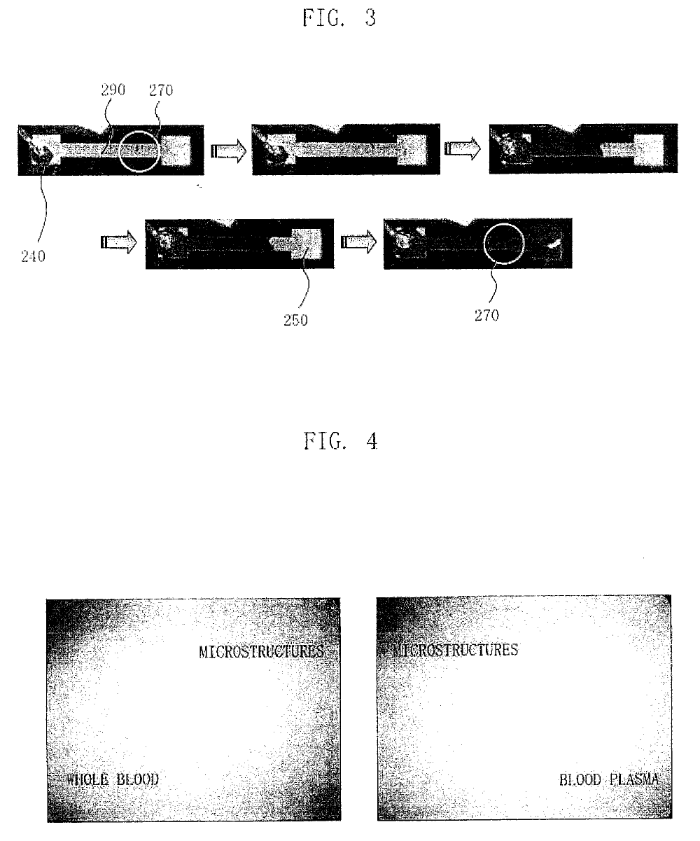

Owing to the vertical movement of the whole blood bath 240, the whole blood sample can be transferred from the whole blood bath 240 to the micro channel 290. In the micro channel 290, blood cells contained in the whole blood sample such as white blood cells, red blood cells, and blood platelets cannot pass between the first microstructures 271. However, components of blood plasma such as water, protein, fat, sugariness, and inorganic ions can pass between the first microstructures 271 (refer to FIGS. 3 and 4).

A bio-substance including desired biological information can be captured from the blood plasma components passing between the first microstructures 271 by using the second microstructures 272. For this, the second microstructures 272 include the complementary capture probe ligands 300 capable of separating or concentrating a bio-substance. Thereafter, other blood plasma components not captured by the probe ligands 300 are temporarily stored in the blood plasma bath 250 and then discharged through the blood plasma outlet 120.

As explained above, the micro filtration device of the current embodiment includes the built-in micro pump (P) capable of generating air pressure without an external actuation. Therefore, the micro filtration device can operate in a simple way, and continuous and efficient separation of blood plasma can be possible using the micro filtration device.

Furthermore, the micro filtration device of the current embodiment includes the complementary capture probe ligands 300. Therefore, a desired bio-substance can be captured from separated blood plasma (and can be concentrated).

In addition, the micro filtration device of the current embodiment can be formed using an inexpensive plastic polymer. Therefore, for example, the micro filtration device can be used in a disposable biochip for detecting a disease using blood.

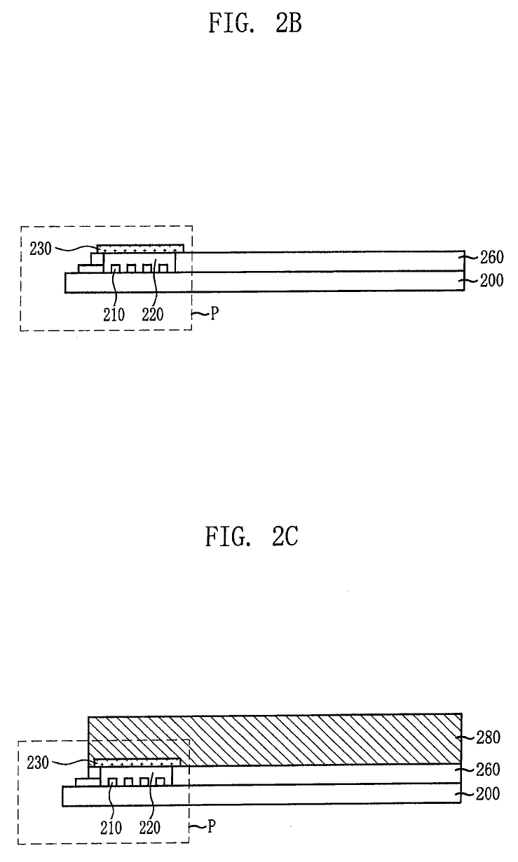

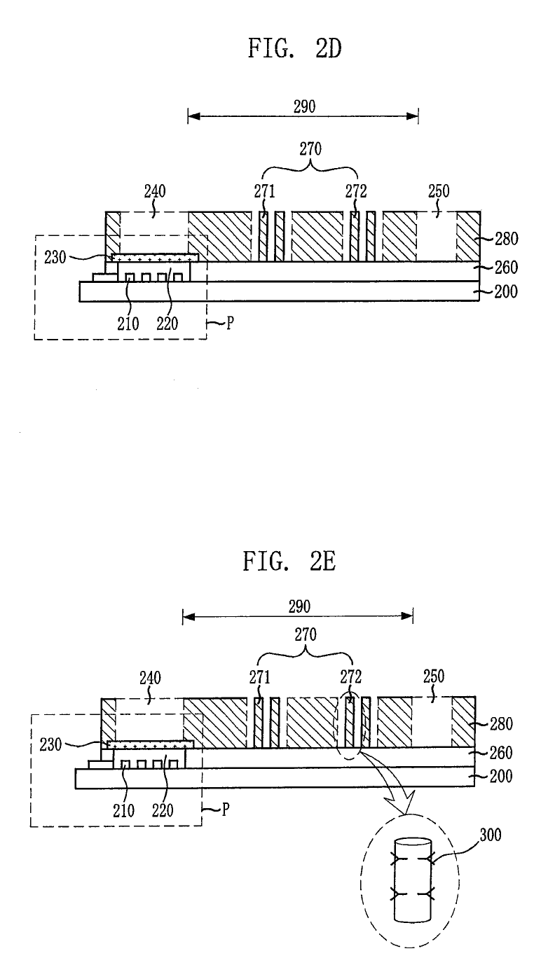

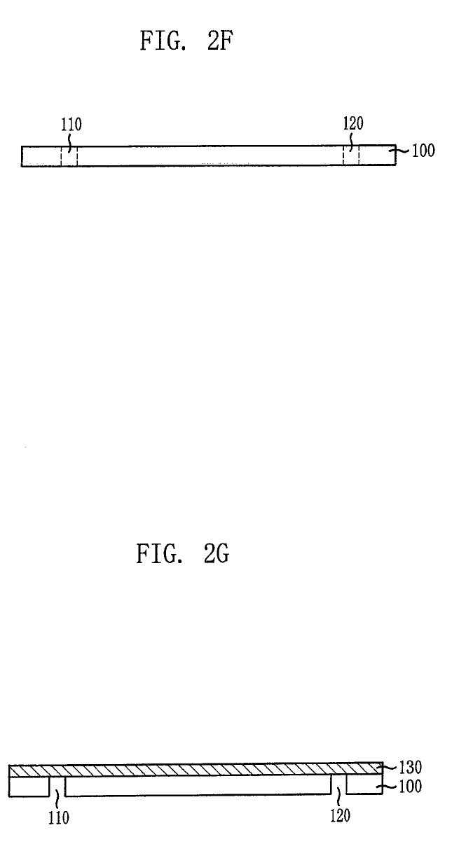

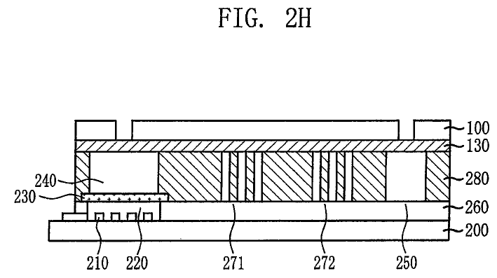

FIGS. 2A to 2H illustrate cross-sectional views corresponding to a section taken along line X-X′ of FIG. 1A for explaining a method for fabricating a micro filtration device in accordance with an embodiment of the present invention. FIGS. 2A to 2E are cross-sectional views for explaining a method of fabricating a lower substrate 200, FIGS. 2F and 2G are cross-sectional views for explaining a method of fabricating an upper substrate 100, and FIG. 2H is a cross-sectional view for explaining a method of bonding and sealing the upper and lower substrates 100 and 200.

Referring to FIG. 2A, a micro heater 210 is formed in a predetermined region of the lower substrate 200. The micro heater 210 may be formed of a conductive material such as gold (Au) to a thickness of about 1000 Å by an E-beam evaporation method.

The micro heater 210 can be formed using various well-known semiconductor manufacturing methods. For example, after forming a conductive layer on the lower substrate 200, the conductive layer can be patterned by photolithography to form the micro heater 210. Alternatively, after forming a photoresist layer pattern on the lower substrate 200, a conductive layer can be formed on the lower substrate 200 including the photoresist layer. Then, the micro heater 210 can be formed by removing the photoresist layer pattern (a lift-off method).

The lower substrate 200 can be formed of one of plastic polymer, silicon, glass, and rubber. For example, the lower substrate 200 can be formed of inexpensive plastic polymer to allow the micro filtration device to be used for a disposable biochip. For example, the lower substrate 200 can be formed of a plastic polymer selected from the group consisting of cycloolefin copolymer (COC), poly-dimethyl siloxane (PDMS), polymethylmethacrylate (PMMA), polycarbonate (PC), polyamide (PA), polyethylene (PE), polypropylene (PP), polyphenylene ether (PPE), polystyrene (PS), polyoxymethylene (POM), polyetheretherketone (PEEK), polytetrafluoroethylene (PTFE), polyvinylchloride (PVC), polyvinylidene fluoride (PVDF), polybutyleneterephthalate (PBT), fluorinated ethylenepropylene (FEP), and perfluoralkoxyalkane (PFA) and combinations thereof.

Referring to FIG. 2B, a support layer 260 is formed on the lower substrate 200 to enclose the micro heater 210. As a result, a cavity 220 can be formed in a region located above the micro heater 210 and enclosed by the support layer 260. The support layer 260 can be formed of an insulation layer such as a silicon oxide layer.

Next, a membrane 230 is disposed above the micro heater 210, and then the membrane 230 is bonded to the support layer 260 by O₂ plasma treatment to close the cavity 220.

The O₂ plasma treatment can be performed for 20 minutes by injecting O₂ gas into a reaction chamber and applying a bias power of about 100 W to the reaction chamber.

Before the membrane 230 is formed, the lower substrate 200 can be placed in a convection oven at a temperature of 70° C. for 30 minutes to remove surface moisture. In this case, the bond between the support layer 260 and the membrane 230 can be increased.

In this way, the micro heater 210, the cavity 220, and the membrane 230 are formed as a micro pump (P).

Referring to FIG. 2C, a first dry film resist (DFR) layer 280 is bonded to the support layer 260 above the lower substrate 200 including the micro pump (P). In detail, the support layer 260 is coated with an interface adhesion promoter such as AP3000 by spin coating. The spin coating can be performed at 2000 rpm for 20 seconds. Next, the first DFR layer 280 can be formed on the support layer 260 to a thickness of about several tens to several hundreds of micrometers by performing a laminating process at a temperature of approximately 120° C. and a pressure of approximately 5 kg/cm².

Referring to FIG. 2D, exposure and development processes are performed using a mask to form a whole blood bath 240, a blood plasma bath 250, a micro channel 290, and microstructures 270 in the first DFR layer 280. The whole blood bath 240 and the blood plasma bath 250 are connected to each other through the micro channel 290, and the microstructures 270 are formed in the micro channel 290.

The exposure and development processes can be repeated one or more times. In other words, the whole blood bath 240, the blood plasma bath 250, the micro channel 290, and the microstructures 270 can be simultaneously formed in the first DFR layer 280 using a single mask; or the whole blood bath 240, the blood plasma bath 250, the micro channel 290, and the microstructures 270 can be sequentially formed in the first DFR layer 280 using two or more masks having different patterns.

For example, the exposure and development processes can be performed using a mask having a pattern corresponding to the whole blood bath 240, the blood plasma bath 250, the micro channel 290, and the microstructures 270 as follows: after mounting the mask on a contact aligner, 20-mW ultraviolet (UV) light is irradiated onto the first DFR layer 280 formed on the lower substrate 200 through the mask, and then the first DFR layer 280 is developed.

The microstructures 270 may include first microstructures 271 and second microstructures 272. The first microstructures 271 may be used for separating blood plasma from whole blood. Complementary capture probe ligands will be formed on the second microstructures 272 for separating and concentrating a desired bio-substance from the separated blood plasma.

Since blood cells such as red blood cells, white blood cells, and blood platelets range in size from approximately 7 μm to approximately 8 μm, the first microstructures 271 may be formed at intervals of 5 μm for separating blood cells from whole blood.

The microstructures 270 may be shaped like a cylinder, a cube, a cuboid, or a polyhedron. At least one microstructure 270 may be disposed in the micro channel 290 (a plurality of microstructures 270 is shown in the embodiment of FIG. 2D). Furthermore, the microstructures 270 may be arranged in the micro channel 290 at regular or irregular intervals.

Referring to FIG. 2E, complementary capture probe ligands 300 are fixed to surfaces of the second microstructures 272 for separating and concentrating a desired bio-substance. The probe ligands 300 can be fixed to the second microstructures 272 as follows: after fixing linker molecules corresponding to the probe ligands 300 to the second microstructures 272, the probe ligands 300 are fixed to the linker molecules. However, other methods can be used to fix the probe ligands 300 to the second microstructures 272. Since such methods have been disclosed in many articles, descriptions thereof will be omitted.

In this way, the lower substrate 200 including the micro pump (P), the whole blood bath 240, the blood plasma bath 250, the micro channel 290, and the microstructures 270 can be formed.

Referring to FIG. 2F, a whole blood inlet 110 and a blood plasma outlet 120 are formed in the upper substrate 100 by drilling. The upper substrate 100 may be formed of one of plastic polymer, silicon, glass, and rubber. For example, the upper substrate 100 can be formed of an inexpensive plastic polymer. In this case, the micro filtration device can be used for inexpensive disposable biochips.

Referring to FIG. 2G, a second DFR layer 130 is bonded to the upper substrate 100 where the whole blood inlet 110 and the blood plasma outlet 120 are formed. Since a DFR layer is not bonded to a hydrophobic surface, the second DFR layer 130 may be not bonded to the upper substrate 100 when the upper substrate 100 is formed of hydrophobic plastic polymer such as cycloolefin copolymer (COC).

In this case, a process such as O₂ plasma treatment may be performed on the upper substrate 100 to change the surface of the upper substrate 100 from hydrophobic into hydrophilic before bonding the second DFR layer 130 to the upper substrate 100. For example, when the upper substrate 100 is formed of COC, the surface of the upper substrate 100 can be changed from hydrophobic into hydrophilic by performing 100-W O₂ plasma treatment on the upper substrate 100 for 20 minutes.

Thereafter, after applying an interface adhesion promoter to the upper substrate 100 by spin coating, the second DFR layer 130 can be bonded to the upper substrate 100. The second DFR layer 130 may have a thickness of several tens of micrometers. The second DFR layer 130 can be bonded to the upper substrate 100 by performing a laminating process at a temperature of about 120° C. and a pressure of about 5 kg/cm².

Although the whole blood inlet 110 and the blood plasma outlet 120 are closed after the second DFR layer 130 is bonded to the upper substrate 100, since the second DFR layer 130 has a thin thickness of about several tens of micrometers, the whole blood inlet 110 and the blood plasma outlet 120 can be opened by a Teflon hose connected to the whole blood inlet 110 or the blood plasma outlet 120 for supplying or discharging blood sample.

In this way, the upper substrate 100 including the whole blood inlet 110 and the blood plasma outlet 120 can be formed.

Referring to FIG. 2H, the upper substrate 100 including the whole blood inlet 110 and the blood plasma outlet 120 is hermetically bonded to the lower substrate 200 including the micro pump (P), the whole blood bath 240, the blood plasma bath 250, the micro channel 290, and the microstructures 270.

The upper substrate 100 and the lower substrate 200 may be hermetically bonded together as follows: after coating the lower substrate 200 with an interface adhesion promoter, the upper substrate 100 is aligned above the lower substrate 200 with the second DFR layer 130 facing the first DFR layer 280. Then, a laminating process is performed at a temperature of about 120° C. and a pressure of about 5 kg/cm² for hermetically bonding the upper substrate 100 and the lower substrate 200.

FIG. 3 is a view illustrating experiment procedures for separating blood plasma from whole blood using a micro filtration device fabricated in accordance with an embodiment of the present invention, and FIG. 4 is an enlarged view illustrating a microstructure portion of FIG. 3. The micro filtration device of FIG. 3 is the same as micro filtration device illustrated in FIGS. 1A and 1B except that microstructures 270 of the micro filtration device of FIG. 3 include only first microstructures 271 for separating blood plasma from whole blood.

Referring to FIGS. 3 and 4, whole blood is introduced into the micro filtration device through a whole blood inlet and temporarily stored in a whole blood bath 240. Then, the whole blood is moved along a micro channel 290 by a micro heater disposed under the whole blood bath 240. That is, the micro heater moves the whole blood without receiving external actuation. While the whole blood flows along the micro channel 290, blood cells are separated from the whole blood by the microstructures 270 formed in the micro channel 290, and then remaining components (blood plasma) of the whole blood further flow to a blood plasma bath 250.

As described above, since the micro filtration device of the present invention includes the micro pump, the micro filtration device can be operated in a simple way as compared with a micro filtration device requiring external actuation. Therefore, blood plasma can be continuously separated from whole blood more efficiently and rapidly. Furthermore, blood plasma separation efficiency is not decreased by blood cells accumulated on the microstructures of the micro filtration device.

In other words, the micro filtration device includes the built-in micro pump capable of generating air pressure without an external actuation. Therefore, the micro filtration device can separate blood plasma from whole blood in a simple way as compared with a micro filtration device requiring external actuation for separating blood plasma.

Furthermore, continuous and efficient separation of blood plasma can be possible using the micro filtration device of the present invention. In addition, the micro filtration device can rapidly separate blood plasma from whole blood. Therefore, blood plasma can be separated from whole blood without a decrease in blood plasma separation efficiency caused by blood cells accumulated on the microstructures of the micro filtration device.

Furthermore, the micro filtration device of the current embodiment includes the complementary capture probe ligands formed on the microstructures. Therefore, a desired bio-substance can be captured from separated blood plasma and can be concentrated.

In addition, the micro filtration device of the current embodiment can be formed using an inexpensive plastic polymer. Therefore, for example, the micro filtration device can be used in a disposable biochip for detecting a disease using blood.

While the present invention has been described with respect to the specific embodiments, it will be apparent to those skilled in the art that various changes and modifications may be made without departing from the spirit and scope of the invention as defined in the following claims.

What is claimed is:

1. A micro filtration device for separating blood plasma from whole blood, comprising:
a whole blood inlet through which whole blood is introduced;
a blood plasma outlet through which blood plasma separated from whole blood is discharged;
a micro channel for connecting the whole blood inlet and the blood plasma outlet;
a micro pump formed under the whole blood inlet to generate an air pressure without external actuation for moving whole blood from the whole blood inlet toward the blood plasma outlet through the micro channel; and
a microstructure formed in the micro channel for separating blood plasma from the whole blood.

2. The micro filtration device of claim 1, wherein the micro pump comprises:
a closed cavity;
a micro heater generating heat for expanding air filled in the cavity; and
a membrane formed in the cavity and deforming according to pressure variations of the air filled in the cavity.

3. The micro filtration device of claim 1, wherein the microstructure comprises:
a first microstructure configured to separate blood plasma from whole blood; and
a second microstructure to which a complementary capture probe ligand is coupled for separating and concentrating a desired bio-substance.

4. The micro filtration device of claim 1, further comprising a whole blood bath formed between the whole blood inlet and the micro pump for storing whole blood introduced through the whole blood inlet.

5. The micro filtration device of claim 4, wherein the whole blood bath is kept at a temperature lower than a body temperature so as to prevent bio-substances contained in a whole blood sample from being damaged by heat generated from the micro pump.

6. The micro filtration device of claim 1, further comprising a blood plasma bath formed under the blood plasma outlet for storing blood plasma separated from whole blood.

7. The micro filtration device of claim 1, wherein the whole blood inlet and the blood plasma outlet are formed at an upper substrate, and the micro channel and the micro pump are formed at a lower substrate, wherein the upper and lower substrates are aligned with each other and sealed.

8. The micro filtration device of claim 7, wherein each of the upper and lower substrates is formed of a plastic polymer.

9. The micro filtration device of claim 8, wherein the plastic polymer is one selected from the group consisting of cycloolefin copolymer (COC), poly-dimethyl siloxane (PDMS), polymethylmethacrylate (PMMA), polycarbonate (PC), polyamide (PA), polyethylene (PE), polypropylene (PP), polyphenylene ether (PPE), polystyrene (PS), polyoxymethylene (POM), polyetheretherketone (PEEK), polytetrafluoroethylene (PTFE), polyvinylchloride (PVC), polyvinylidene fluoride (PVDF), polybutyleneterephthalate (PBT), fluorinated ethylenepropylene (FEP), perfluoralkoxyalkane (PFA) and combinations thereof.

10. The micro filtration device of claim 2, wherein the micro heater is formed of a conductive material and receives an external pulse bias.

11. A method for fabricating a micro filtration device, the method comprising the steps of:
a) forming a whole blood inlet at one side of an upper substrate for introducing whole blood;
b) forming a blood plasma outlet at the other side of the upper substrate for discharging blood plasma separated from whole blood;
c) forming a micro pump at a portion of a lower substrate corresponding to the whole blood inlet for generating an air pressure without external actuation to move whole blood;
d) forming a micro channel at the lower substrate to connect the whole blood inlet and the blood plasma outlet, and forming a microstructure in the micro channel so as to separate blood plasma from whole blood; and
e) bonding the upper substrate and the lower substrates for hermetical sealing.

12. The method of claim 11, wherein the step c) includes the steps of:
c1) forming a micro heater at the lower substrate;
c2) forming a support layer around the micro heater to form a cavity; and
c3) forming a membrane on the support layer to close the cavity.

13. The method of claim 12, wherein the micro heater is formed of a conductive material and receives an external pulse bias.

14. The method of claim 12, wherein the support layer is formed of a silicon oxide layer.

15. The method of claim 12, wherein the membrane is bonded to the support layer by O₂ plasma treatment.

16. The method of claim 12, further comprising, prior to the step c3), the step of:
f) pre-treating the lower substrate in a convection oven so as to secure a bond between the membrane and the support layer.

17. The method of claim 11, wherein the step d) includes the steps of:
d1) bonding a dry film resist (DFR) layer to the lower substrate; and
d2) exposing and developing the dry film resist layer using a mask having a pattern corresponding to the micro channel and the microstructure.

18. The method of claim 11, further comprising the step of:
f) forming a complementary capture probe ligand on the microstructure for separating a desired bio-substance.

19. The method of claim 11, further comprising the steps of:
f) forming a whole blood bath at the lower substrate for storing whole blood; and
g) forming a blood plasma bath at the lower substrate for storing blood plasma separated from whole blood.

20. The method of claim 11, wherein the upper and lower substrates are sealed by laminating.

21. The method of claim 11, wherein each of the upper and lower substrates is formed of a plastic polymer.

22. The method of claim 21, wherein the plastic polymer is one selected from the group consisting of cycloolefin copolymer (COC), poly-dimethyl siloxane (PDMS), polymethylmethacrylate (PMMA), polycarbonate (PC), polyamide (PA), polyethylene (PE), polypropylene (PP), polyphenylene ether (PPE), polystyrene (PS), polyoxymethylene (POM), polyetheretherketone (PEEK), polytetrafluoroethylene (PTFE), polyvinylchloride (PVC), polyvinylidene fluoride (PVDF), polybutyleneterephthalate (PBT), fluorinated ethylenepropylene (FEP), and perfluoralkoxyalkane (PFA) and combinations thereof.
